(19) United States
(12) Patent Application Publication
(10) Pub. No.: US 2016/0105871 A1
(43) Pub. Date: Apr. 14, 2016

(54) ADDITIONAL CONFIGURATION OF SMALL CELL NETWORK DATA RESOURCE USING COMMON REFERENCE SIGNAL

(71) Applicant: INTELLECTUAL DISCOVERY CO., LTD., Seoul (KR)

(72) Inventors: Jinsam KWAK, Uiwang-si (KR); Juhyung SON, Uiwang-si (KR)

(73) Assignee: Intellectual Discovery Co., Ltd., Seoul (KR)

(21) Appl. No.: 14/787,795

(22) PCT Filed: Apr. 30, 2014
(86) PCT No.: PCT/KR2014/003879

§ 371 Date: Oct. 29, 2015

(30) Foreign Application Priority Data
Apr. 30, 2013 (KR) 10-2013-0048970
Apr. 30, 2013 (KR) 10-2013-0048972
Apr. 30, 2013 (KR) 10-2013-0048973
Apr. 30, 2013 (KR) 10-2013-0048975

(51) Int. Cl. H04W 72/04; H04W 56/00

(52) U.S. Cl. CPC H04W 72/042; H04W 56/0015; H04W 72/048; H04W 84/042

(57) ABSTRACT

The present disclosure relates to a wireless communication system. The present disclosure relates to a wireless communication system supporting at least one of SC-FDMA, MC-FDMA and OFDMA, and more particularly, to a method for transmitting a reference signal in a wireless communication system. The present disclosure proposes a method for selecting, from common reference signals, a reference signal in a downlink data region and assigning the selected reference signal to a scheduling channel of the downlink data for data transfer, further proposes a method for selecting some common reference signals and diverting them to demodulation reference signals, and thereby promotes a reduction of the system overhead and an increase of data transmission capacity. Moreover, the present disclosure proposes preventing malfunction of the legacy terminals with a method for transmitting and receiving related information between terminals and base stations.

### TECHNICAL FIELD

The present disclosure relates to a wireless communication system. More particularly, the present disclosure relates to a method for transmitting a reference signal in a wireless communication system.

### BACKGROUND

A Third Generation Partnership Project (3GPP) wireless communication system based on wideband code division multiple access (WCDMA) radio access technology has been widely deployed throughout the world. High speed downlink packet access (HSDPA), which can be defined as the first evolutionary step of WCDMA, provides the 3GPP with a wireless connection technology having a high competitiveness in the near future.

An Evolved Universal Mobile Telecommunication System (E-UMTS) is intended to provide a competitive edge in the distant future. Having evolved from existing WCDMA UMTS, the E-UMTS is under the process of standardization in the 3GPP. The E-UMTS is also referred to as a Long Term Evolution (LTE). For more information on the UMTS and E-UMTS technical specifications, reference can be made to “3rd Generation Partnership Project; Technical Specification Group Radio Access Network” Release 8 or later version.

The E-UMTS generally involves a user terminal or equipment (UE), a base station and an access gateway (AG) located at an end of a network (E-UTRAN) and is connected to an external network. Typically, the base station can transmit multiple data streams at the same time for the purpose of a broadcast service, a multicast service and/or a unicast service. The LTE system utilizes an Orthogonal Frequency Divisional Multiplexing (OFDM) and Multiple Input Multiple Output (MIMO) antenna to perform downlink transmissions for a variety of services.

The OFDM is a high-speed downlink data access system. It has an advantage of high spectral efficiency, whereby all allocated spectrums can be used by all base stations. A transmission band for an OFDM modulation is divided into multiple orthogonal subcarriers in frequency domain and into a plurality of symbols in time domain. The division of transmission bands in the OFDM into multiple orthogonal subcarriers enables the deduction of the bandwidth for each subcarrier and increasement of the modulation time for each carrier wave. The plurality of subcarriers are transmitted in parallel and therefore digital data or symbol transmission rates of a particular subcarrier are lower than those of the single carrier.

The multi-antenna or the MIMO system is a communication system using multiple transmission and receive antennas. With increasing number of transmission and receive antennas, the MIMO system can linearly increase the channel capacity without additional increase of bandwidth. The MIMO technology adopts a spatial diversity scheme that can enhance the reliability of transmission by utilizing symbols passing through a variety of channel paths and a spatial multiplexing scheme for increasing the transmission rate with a plurality of transmit antennas respectively transmitting separate data streams at the same time.

The MIMO technology can be classified into an open-loop MIMO technology and a closed-loop MIMO technology, depending on whether the transmitting end possesses a channel information. The transmitting end in the open-loop MIMO has no knowledge of the channel information. Examples of the open-loop MIMO technology include PARC (per antenna rate control), PCBRC (per common basis rate control), BLAST, STTC, random beamforming and the like. On the other hand, the transmitting end in the closed-loop MIMO technology possesses the channel information. The performance of the closed-loop MIMO system is dependent on the accuracy of knowledge about the channel information. Examples of the closed-loop MIMO technology are PSRC (per stream rate control), TxAA and the likes.

The channel information refers to information on a the radio channel (e.g., attenuation, phase shift or time delay, etc.) between multiple transmit antennas and multiple receive antennas. The MIMO system establishes a variety of stream paths through combinations of a plurality of transmission and receive antennas and has fading characteristics by which the channel state shows irregular variation by time in the time/frequency domain due to a multi-path time delay. Therefore, the transmitting end calculates the channel information via a channel estimation. The channel estimation is designed to estimate the channel information needed to reconstruct the transmitted signal after distortion. For example, the channel estimation refers to estimating the magnitude and reference phase of a carrier wave. In other words, the channel estimation serves to estimate the frequency response of the radio band or the wireless channel.

A known channel estimation method involves performing, by a two-dimensional channel estimator, a reference value estimation based on reference signals (RS) of several base stations. In this case, the RS refers to a symbol that is not actually assigned data but has a high output for use in phase synchronization of carrier wave and acquisition of base station information. The transmitter side and receiver side can use such RS to perform the channel estimation. The channel estimation by the RS is achieved through the symbol commonly known to the transmitter and receiver sides, and the estimate is used to reconstruct the data. The RS is also referred to as a pilot. The MIMO system supports time division duplex (TDD) systems and a frequency division duplex (FDD) systems. In the TDD system, a forward and a reverse link transmissions are performed in the same frequency domain, and therefore a forward link channel can be estimated from the reverse link channel according to the reciprocity principle.

### DISCLOSURE

### Technical Problem

Therefore, the present disclosure provides a method for transmitting a reference signal suitable for a small cell by using a common reference signal.

The present disclosure further provides an apparatus for transmitting a common reference signal and a demodulation reference signal suitable for the channel environment of the small cell and for the allocation of additional resources.

Every time a communication system evolves, performance improvement of existing systems is preferred over a new system definition for the ever-changing communication technology as a way of achieving the objectives at the minimum possible cost. In particular, the communication system has possible influences not just on RF interfaces of terminals or base stations but also on all infrastructure facilities, and therefore minimizing change of the system would be commercially significant. In this context, a new version of communication system will be restricted to maintain the characteristics of the existing system. Particularly, an important requirement is to provide the functionality of the new system without degrading the performance of the existing system, which is applied to LTE/LTE-A release 8/9/10 or later versions. The same requirement also applies to IEEE 802.16m and other communication systems when they are required to ensure operation of legacy systems. The performance improvement basically involves techniques including increasing the modulation order or the number of antennas and reducing the effects of interference, which requires more reference signals (RS). In other words, transmission of more information would be provided by an apparatus capable of recognizing more channel information and distinguishing respective signal components. Currently, LTE Rel-8 is adapted to support up to four antennas. Meanwhile, LTE-A is intended to support up to eight antennas. However, typical OFDM-based communication systems insert a reference signal to a specific position and perform channel estimation at that position. The other remaining subcarriers are used for data and control channels. When working under this condition for future system improvement, inherent lack of flexibility disables inserting an additional reference signal or reducing reference signals to be appropriately used for data and control channels.

However, in the various cell topologies such as a femtocell and a picocell with cell coverage whose range is less than 100 m like the small cell, the radio channel delay characteristics experienced by each cell are different from those of cells with larger coverages, which makes it better to reduce the overhead of reference signals taking into account the frequency selectivity of the radio channel and to reallocate resources to data transmission so as to improve system performance. Moreover, in order to reduce the occurrence of frequent handover resulting from configuration of small cells, small cells may be better used by pedestrians or stationary users, which may restrict the terminal to be slow/still in terms of mobility. In this case, the terminal has radio channel time selectivity different from that of a fast-moving object, and therefore it is more better to re-design the reference signal to reduce the overhead of the reference signal and use the corresponding resources for the purpose of the data or control channel.

In this context, some embodiments of the present disclosure provide a method for efficiently transmitting/receiving a reference signal in consideration of the small-cell environment in a wireless communication system with multiple antennas and a signaling method thereof.

Some embodiments of the present disclosure provide a method for efficiently transmitting/receiving a reference signal in case of expanding the number of antennas and a signaling method thereof.

Some embodiments of the present disclosure provide a method for transmitting/receiving a reference signal while having backward compatibility in case of expanding the number of antennas and a signaling method thereof.

The technical challenges to be overcome by the present embodiments are not limited to the aforementioned technical matters, and other unmentioned matters will be clearly understood from the description below by those skilled in the art to which the present disclosure pertains.

### SUMMARY

In accordance with some embodiments of the present disclosure, a method for allocating an additional data resource and a demodulation reference signal suitable for a small cell using a common reference signal includes classifying a region for allocation of a downlink control channel and a downlink data region, separating the common reference signal by using an information on the classified region, selecting a reference signal of the extracted downlink data resource region; and reallocating the selected reference signal to the demodulation reference signal or a data subcarrier resource.

In accordance with some embodiments of the present disclosure, provided herein is a cellular communication system including a macro cell which uses downlink common reference signals and a heterogeneous cells which use a part of downlink common reference signal for transmission of data for terminals. Provided herein is a method for transmitting a common reference signal and data in a wireless communication system, the method including generating subframes by classifying common reference signal transmission resources into first transmission resources and second transmission resources, allocating the common reference signal through the first transmission resources, allocating the data through the second transmission resources, and transmitting the subframe. The first transmission resources include common reference signal resources in a downlink control channel resource region, and the second transmission resources do not include any common reference signal resources in the downlink control channel resource region. The data transmitted on the second transmission resources are used by an arbitrary antenna port.

In accordance with some embodiments of the present disclosure, a method for operating a user terminal in a communication system in which a macrocell and a small cell coexist, includes (a) receiving a radio signal which is resourced by a first resource group including user data of a pertaining small cell and a downlink common reference signal of the macrocell, the user data overlapping the downlink common reference signal and a second resource group including the downlink common reference signals of the pertaining small cell and the macrocell, and (b) demodulating the user data included in the first resource group. Herein, the method may further include performing a channel estimation based on the downlink common reference signal included in the first resource group. The demodulating may include demodulating the user data based on the result of the channel estimation.

In accordance with some embodiments of the present disclosure, a method for operating a user terminal in a communication system in which a macrocell and a small cell coexist, includes (a) receiving a radio signal which is resourced by a first resource group including a demodulation reference signal of a pertaining small cell and a downlink common reference signal of the macrocell, the demodulation reference signal overlapping the downlink common reference signal and a second resource group including the downlink common reference signals of the pertaining small cell and the macrocell, and (b) demodulating user data based on the demodulation reference signal included in the first resource group.

In accordance with some embodiments of the present disclosure, a method for operating a user terminal in a macrocell including multiple base stations coexisting therein includes receiving, respectively from a first base station and second base station, an information about a reference signal transmission method respectively used by the first and second base stations, selecting the base station to access based on the received information, and requesting an access to the selected base station.

The first base station may operate based on a method for using all resources for a common reference signal in the macro cell to transmit the common reference signal, and the second base station may operate based on a method using a part of the resources for the common reference signal in the macro cell to transmit the common reference signal and the remaining resources to transmit a user data. The first base station may operate based on a method for using all the resources for the common reference signal in the macro cell to transmit the common reference signal, and the second base station may operate based on a method for using a part of the resources for the common reference signal in the macro cell to transmit the common reference signal and the remaining resources to transmit a demodulation reference signal. The receiving of the information may include receiving the information about the common reference signal transmission method over a synchronization channel.

In accordance with some embodiments of the present disclosure, a method for transmitting a reference signal in a wireless communication system includes generating subframes by classifying common reference signal transmission resources into first transmission resources and second transmission resources, allocating the common reference signal through the first transmission resources, allocating a demodulation reference signal through the second transmission resources, and transmitting the subframe. The first transmission resources include common reference signal resources in a downlink control channel resource region, and the second transmission resources do not include any common reference signal resources in the downlink control channel resource region. The demodulation reference signal transmitted on the second transmission resources is used to distinguish between user transmission layers through an orthogonal code.

In accordance with some embodiments of the present disclosure, provided herein is a cellular communication system including a first cell using a plurality of resources to transmit a downlink common reference signal, and a second cell using a part of the plurality of resources to transmit the downlink common reference signal and the remaining resources to transmit a user data. Transmission of the user data may be downlink transmission, and the resources used to transmit the user data may be used by an arbitrary antenna port, wherein the first cell may be a macrocell, and the second cell may be a small cell, wherein the small cell may be one of a picocell, femtocell and microcell.

In accordance with some embodiments of the present disclosure, provided herein is a cellular communication system including a first cell using a plurality of resources to transmit a downlink common reference signal, and a second cell using a part of the plurality of resources to transmit the downlink common reference signal and the other resources to transmit a demodulation reference signal. Transmission of the demodulation reference signal may be downlink transmission, and an orthogonal code may be applied to the demodulation reference signal to distinguish between users, wherein, the first cell may be a macrocell, and the second cell may be a small cell, wherein the small cell may be one of a picocell, a femtocell and a microcell.

In accordance with some embodiments of the present disclosure, a method for generating a frame for a small cell base station includes classifying a plurality of resources used by a macrocell to transmit a downlink common reference signal into a first resource group and second resource group including at least one resource, and allocating a common reference signal to the first resource group and a user data to the second resource group.

In accordance with some embodiments of the present disclosure, a method for operating a user terminal in a macrocell including multiple base stations coexisting therein includes requesting an access to the base stations, receiving, from the base stations, an information about a common reference signal generation method selected from among a plurality of common reference signal generation methods, and performing a user data reception based on the received information. The method may further include transmitting, to the base stations, an information used to select the common reference signal generation method, wherein the information may include a reception capability of the user terminal.

In accordance with some embodiments of the present disclosure, a cellular communication system for transmitting different common reference signals from a plurality of base stations including a macrocell includes requesting, by a terminal, an access to a specific base station, determining, by the base station, a common reference signal generation method according to the request of the terminal and generating a subframe including a determined common reference signal. When requesting the access to the specific base station, an information about the capability of a terminal of receiving a common reference signal is transmitted. The different common reference signals include a part of common reference signals of the macrocell reassigned to be used as data or demodulation reference signals. The determining of the common reference signal generation method informs a terminal with an existing access of whether or not the common reference signal is modified in response to the common reference signal generation method being changed so that a modified common reference signal is generated when there is at least one terminal capable of receiving the modified common reference signal.

In accordance with some embodiments of the present disclosure, a method for operating a base station in a macrocell including multiple base stations coexisting therein includes selecting one of a plurality of common reference signal generation methods, and generating a subframe based on the selected common reference signal generation method. The transmitting may include transmitting the information through a synchronization channel.

Herein, the plurality of common reference signal generation methods may include at least two of a first common reference signal generation method for using all resources for a common reference signal in the macro cell to transmit the common reference signal, a second common reference signal generation method for using a part of the resources for the common reference signal in the macro cell to transmit the common reference signal and using the remaining resources to transmit a user data, and a third common reference signal generation method for using a part of the resources for the common reference signal in the macro cell to transmit the common reference signal and using the remaining resources to transmit a demodulation reference signal. The selecting of the common reference signal generation method may include selecting the second method in response to the existence of only user terminals that support the second method. In addition, the selecting of the common reference signal generation method may include selecting the third method in response to the existence of only user terminals that support the third method. The selecting of the common reference signal generation method may include selecting one of the common reference signal generation methods based on a reception capability information of a user terminal that requests an access. The method may further include transmitting an information on the selected common reference signal generation method to a user terminal.

In accordance with some embodiments of the present disclosure, a method for operating a base station in a macrocell including multiple base stations coexisting therein includes generating and transmitting a subframe based on a first common reference signal generation method, and generating and transmitting the subframe based on a second common reference signal generation method in response to an occurrence of an event to change the common reference signal generation method. The method may further include notifying a user terminal of whether or not the common reference signal generation method is changed.

In accordance with some embodiments of the present disclosure, a cellular communication system for transmitting different common reference signals from a plurality of base stations including a macrocell includes transmitting, by the base stations, a transmission method for a common reference signal, selecting, by a terminal, a base station for transmitting a specific common reference signal, and requesting, by the terminal, an access to the selected base station. The transmitting of the common reference signal transmission method by the base station announces whether or not a legacy common reference signal is utilized as data or a demodulation reference signal. The different common reference signals include a part of common reference signals of the macrocell reassigned to be used as data or demodulation reference signals. The terminal selecting the base station for transmitting the specific common reference signal has a terminal reception capability of receiving and utilizing the relevant common reference signal, and the transmitting of the common reference signal transmission method adds an information on a transmission of the system information of the base station as it occurs. Herein, the transmitting of the common reference signal transmission method may add the an information on a synchronization channel transmission of the base station as it occurs.

### Advantageous Effects

According to the present disclosure as described above, the following effects are provided.

The overhead of reference signals may be reduced, and resources may be reallocated to data transmission.

A specific transmission mode can be supported without adding overhead by reassigning a common reference signal to be used as a demodulation reference signal.

Effects that can be obtained from the present disclosure are not limited to the aforementioned, and other effects may be clearly understood by those skilled in the art from the descriptions given below.

### BRIEF DESCRIPTION OF DRAWINGS

To facilitate understanding of the present disclosure, the accompanying drawings included as part of the detailed description will present some embodiments of the present disclosure and an explanation of the technical idea of the present disclosure in conjunction with the detailed description.

FIG. 1 is a diagram of the structure of a radio frame used in 3GPP LTE.

FIG. 2 is a diagram of a resource grid of one downlink slot.

FIG. 3 is a diagram of the structure of a downlink radio frame.

FIG. 4 is a diagram of control channels allocated to a downlink subframe.

FIG. 5 is a diagram of the structure of a demodulation-reference signal (DM-RS) when using one or two reference signals.

FIG. 6 is a diagram of the structure of a demodulation-reference signal (DM-RS) when using more than two reference signals.

FIG. 7 is a diagram of the structure of an uplink reference signal in a slot in case of PUSCH transmission.

FIG. 8 is a diagram of an uplink reference signal generation process from a reference signal sequence in the frequency domain.

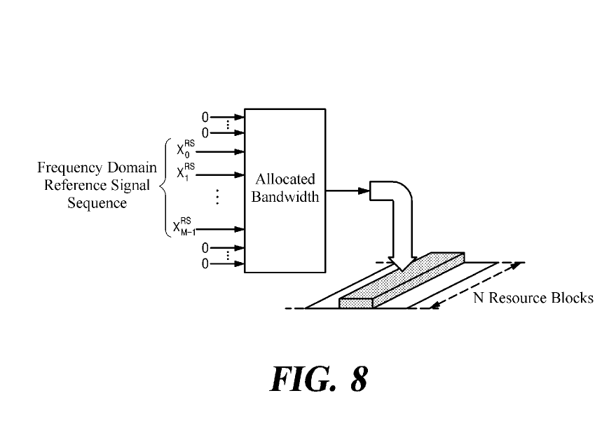

FIG. 9 is a diagram of common reference signals or cell-specific reference signals (CRS).

FIG. 10 is an exemplary diagram of reallocating a part of the reference signal to a data region per antenna port 0 or 1 assigned to the common reference signal.

FIG. 11 is an exemplary diagram of reallocating a part of the reference signal outside of a PDCCH region to a data region per antenna port 0 or 1 assigned to the common reference signal.

FIG. 12 is an exemplary diagram of reallocating a part of the reference signal per antenna port 0 or 1 assigned to the common reference signal, as a demodulation reference signal.

FIG. 13 is an exemplary diagram of reallocating a part of the reference signal outside of a PDCCH region per antenna port 0 or 1 assigned to the common reference signal, as a demodulation reference signal.

FIG. 14 is a diagram of a small cell network configuration in consideration of multi-layer cells.

FIG. 15 is a diagram of an operational process between new base stations capable of modifying the common reference signal when a UE accesses a base station.

FIG. 16 is a diagram of a base station selection process performed by a terminal when a plurality of base stations uses heterogeneous common reference signal transmission schemes.

FIG. 17 is a diagram of a process of transmitting an indicator of transmission of a modified common reference signal over a synchronization channel.

### DETAILED DESCRIPTION

Some embodiments described herein are intended to clearly explain the concept of the present disclosure to those of ordinary skill in the art to which this disclosure pertains, not to limit the present disclosure thereto, and the scope of the disclosure should be construed to include modifications and variations that do not depart from the technical idea of the disclosure.

The accompanying drawings and terms used in this specification are intended to facilitate explanation of the present disclosure, and the shapes illustrated in the drawings are exaggerated as needed to aid in understanding of the present disclosure. Therefore, the present disclosure is not to be limited by the terms and accompanying drawings that are used herein.

Further, in the following description of the at least one embodiment, a detailed description of known functions and configurations incorporated herein will be omitted so as not to obscure the subject matter of the present disclosure.

Configuration, operation and other features of the present disclosure will be readily understood from the embodiments of the present disclosure described herein with reference to the accompanying drawings. Some embodiments described below are example applications of the technical features of the present disclosure to a wireless communication system. The wireless communication system may support at least one of SC-FDMA, MC-FDMA and OFDMA. Hereinafter, an exemplary description will be given of a method for allocating an additional reference signal over various channels. While the description of a 3GPP LTE channel will be basically given in this specification, examples in this specification may also be applied to a reference signal allocation method utilizing a control channel of IEEE 802.16 (or a revised version thereof) or control channels of other systems.

Abbreviations used herein are as follows:

RE: Resource element

REG: Resource element group

CCE: Control channel element

CDD: Cyclic delay diversity

RS: Reference signal

CRS: Cell specific reference signal or cell common reference signal

CSI-RS: Channel state information reference signal

DM-RS: Demodulation reference signal

MIMO: Multiple input multiple output

PBCH: Physical broadcast channel

PCFICH: Physical control format indicator channel

PDCCH: Physical downlink control channel

PDSCH: Physical downlink shared channel

PHICH: Physical hybrid-ARQ indicator channel

PMCH: Physical multicast channel

PRACH: Physical random access channel

PUCCH: Physical uplink control channel

PUSCH: Physical uplink shared channel

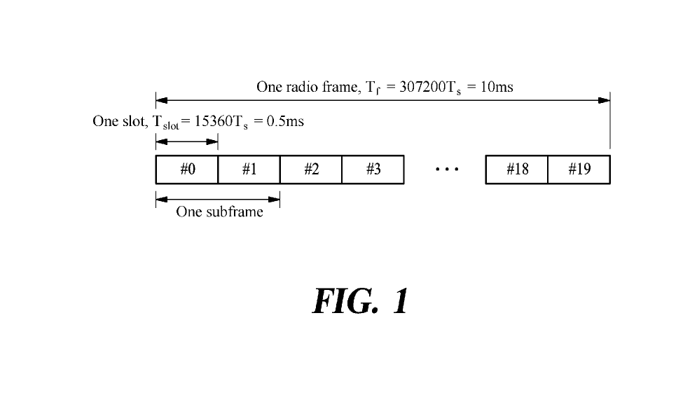

FIG. 1 is a diagram of the structure of a radio frame used in 3GPP LTE.

Referring to FIG. 1, a radio frame has a duration of 10 ms (327200×Tₛ) and includes ten equal-sized subframes. Each subframe has a duration of e.g., 1 ms and is composed of two slots. Each slot has a duration of e.g., 0.5 ms (15360×Tₛ). Herein, Tₛ denotes a sampling time, and is expressed as Tₛ=1/(15 kHz×2048)=3.2552×10-8 (about 33 ns). Each slot includes a plurality of the OFDM symbols in the time domain and a plurality of resource blocks in the frequency domain. A transmission time interval (TTI), which is a unit time duration during which data is transmitted, may be defined by the unit of at least one subframe. The structure of the radio frame described above is simply illustrative. The number of subframes included in a radio frame, the number of slots included in a subframe, or the number of OFDM symbols included in a slot may be changed as necessary.

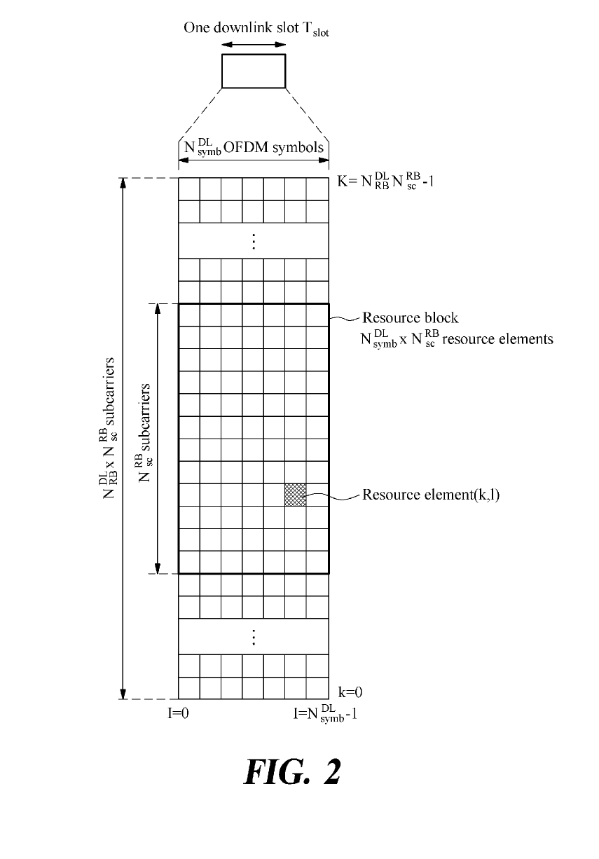

FIG. 2 is a diagram of a resource grid of one downlink slot. Referring to FIG. 2, a downlink slot includes N^{DL}_{symb} OFDM symbols in the time domain and N^{DL}_{RB} resource blocks in the frequency domain. Each resource block includes N^{RB}_{sc} subcarriers, and thus one downlink slot includes N^{DL}_{RB}×N^{RB}_{sc} subcarriers in the frequency domain. While FIG. 2 illustrates a downlink slot as including seven OFDM symbols and a resource block as including twelve subcarriers, embodiments of the present disclosure are not limited thereto. For example, the number of OFDM symbols included in a downlink slot may be changed depending on the length of a cyclic prefix (CP). Each element on the resource grid is called a resource element and is indicated by one OFDM symbol index and one subcarrier index. One resource block is made of N^{DL}_{symb}×N^{RB}_{sc} REs. The number of resource blocks included in a downlink slot (N^{DL}_{RB}) depends on the downlink transmission bandwidth set in a cell.

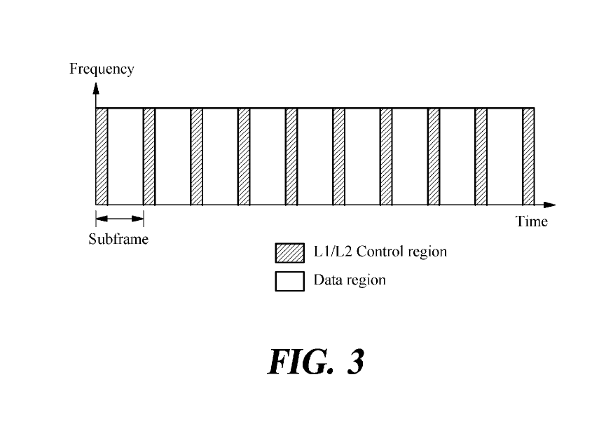

FIG. 3 is a diagram of the structure of a downlink radio frame.

Referring to FIG. 3, a downlink radio frame includes ten equal-sized subframes. Each subframe includes a Layer 1/Layer 2 (L1/L2) control region and a data region. Hereinafter, the L1/L2 control region will be simply referred to as a control region, unless mentioned otherwise. The control region starts from the first OFDM symbol of a subframe and includes one or more OFDM symbols. The size of the control region may be independently set for each subframe. The control region is used to transmit an L1/L2 control signal. To this end, control channels such as PCFICH, PHICH and PDCCH are allocated to the control region. On the other hand, the data region is used to transmit downlink traffic. PDCCH is allocated to the data region.

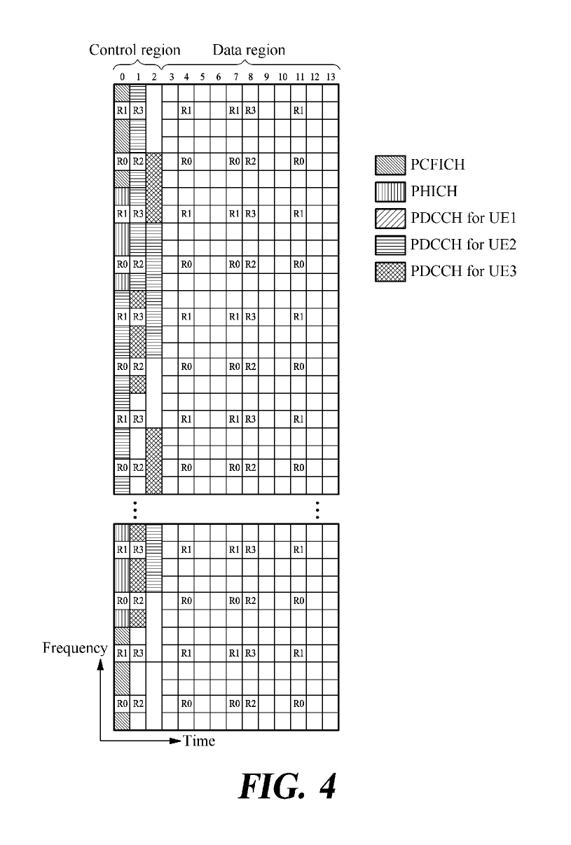

FIG. 4 is a diagram of control channels allocated to a downlink subframe.

Referring to FIG. 4, each subframe includes fourteen OFDM symbols. In a subframe, corresponding to the PCFICH-set number of the OFDM symbols for the control region, one to three leading OFDM symbols are used as the control region, and the remaining thirteen to eleven OFDM symbols are used as the data region. In FIG. 4, R1 to R4 represent RSs for antennas 0 to 3. The RSs maintain a consistent pattern within a subframe in both the control region and the data region. Control channels are allocated in the control region to resources with no allocated RS, and traffic channels are allocated in the data region also to resources with no allocated RS. Control channels allocated to the control region include PCFICH, PHICH and PDCCH, etc.

A downlink reference signal is a predefined signal occupying specific REs within the downlink time-frequency grid. The LTE standards define some kinds of downlink reference signals which are transmitted under different schemes and used for different purposes for the UE (user equipment) receiving the same:

1) A cell-specific reference signal (CRS) is transmitted to all resource blocks in the frequency domain over a whole cell bandwidth for every downlink subframe. The cell-specific reference signal is used for channel estimation for coherent demodulation of all downlink physical channels except for PMCH and PDSCH using transmission modes 7, 8 and 9. Transmission modes 7, 8 and 9 correspond to so-called non-codebook-based precoding. Cell-specific reference signals may also be used for the UE to acquire channel-state information (CSI). Finally, estimates of CRSs by the UE are used to make a cell selection and determine a handover.

2) The reference signal called a demodulation reference signal (DM-RS) or UE-specific reference signal is used for channel estimation for the PDSCH using transmission modes 7, 8 and 9 (and for transmission mode 10, which is additionally defined in Release 11). The DM-RS is also called a UE-specific signal because each DM-RS is actually intended to be used for channel estimation of only one UE. Accordingly, this reference signal is transmitted only within resource blocks allocated to PDSCH transmitted to a specific UE.

3) A CSI reference signal (CSI-RS) is used for the UE to acquire CSI when using the DM-RS for channel estimation. The CSI-RS has a time/frequency density even lower than that of the CRS and is thus subject to lower overhead.

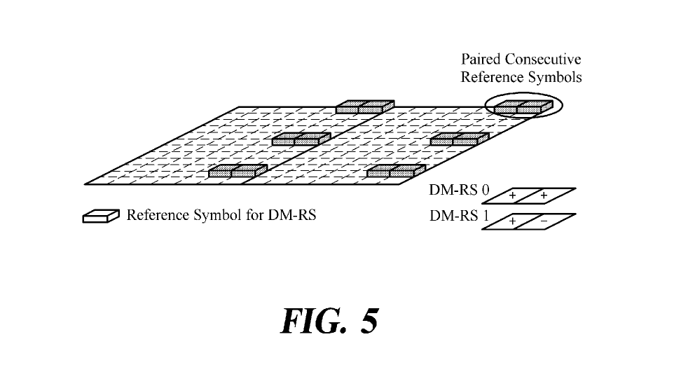

FIG. 5 is a diagram of the structure of a DM-RS when using one or two reference signals. As can be seen from the diagram, a resource block pair includes twelve reference symbols. As opposed to the CRS where an RE being used by one antenna port as a reference symbol is not used by another antenna port, two DM-RSs utilized cause the twelve reference symbols to be transmitted for both of the reference signals, that is, transmitted from both antenna ports. In this case, the interference between the reference signals is resolved by applying mutually orthogonal patterns called an orthogonal cover code (OCC) to consecutive paired reference symbols. In addition to the mutually orthogonal patterns, a pseudo-random sequence may be applied to reference symbols. This sequence is common to both reference signals and does not affect orthogonality between the two transmitted reference signals. Rather, the pseudo-random sequence is intended to separate different DM-RSs transmitted to different UEs in so-called MU-MIMO transmission.

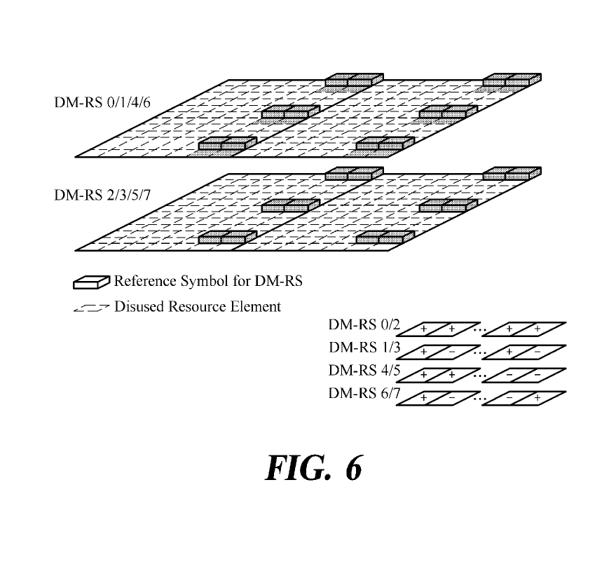

FIG. 6 is a diagram of the structure of a DM-RS when using more than two reference signals. FIG. 6 shows an extended DM-RS structure introduced in LTE release 10 to support more than two reference signals. In this case, a resource block pair includes 24 reference symbols. Reference signals are frequency multiplexed for each of four groups of reference signals. Reference signals in a group are separated from each other by using an orthogonal pattern covering four reference symbols (i.e., two pairs of consecutive reference symbols). It is noted that orthogonality among eight reference signals can be ensured only by having a channel kept unchanged in a reference signal interval to which an orthogonal pattern is applied. Since the four reference symbols are not actually consecutive in the time domain, there is a significant restriction to estimating change of channels without losing orthogonality between the reference signals. More than four reference signals are employed only in the case of spatial multiplexing for more than four layers, and such transmission modes are generally applied only on the condition that UEs move at low speed. Additionally, it is noted that, when four or fewer reference signals are used, an orthogonality pattern is already determined such that orthogonality is obtained between paired reference symbols. Accordingly, restrictions on channel estimation and channel change speed, which are applied when three or four reference signals are employed, are the same as those applied when the one or two reference signals are employed.

Reference signals are transmitted on LTE uplink as well as downlink. For LTE uplink, there are two types of reference signals.

1) Uplink DM-RS. This signal is used by a base station to perform channel estimation for coherent demodulation of uplink physical channels (PUSCH and PUCCH). The DM-RS is always transmitted together with PUSCH or PUCCH, over the same bandwidth as used for the physical channels.

2) Uplink sounding reference signal (SRS). This signal is used by a base station to perform channel estimation for channel-dependent scheduling and link adaptation according to uplink channels. The SRS is also used when there is no data to be transmitted, but an uplink transmission is needed. For example, when a network adjusts the uplink transmission timing according to an uplink-timing-alignment procedure, the uplink transmission may be needed. Finally, the SRS may also be used to estimate a downlink channel state when there is a sufficient reciprocity between uplink/downlink channels, namely when characteristics of an uplink channel are sufficiently similar to those of a downlink channel. This usage particularly draws high attention in the TDD system, which has the downlink/uplink reciprocity even higher than that of the FDD system when the same carrier frequency is used for downlink and uplink.

A low cubic metric and the corresponding high efficiency of a power amplifier are important for uplink transmission, and thus the principle applied to uplink reference signal transmission is different from that for the downlink. Basically, it is inappropriate for one UE to perform an uplink transmission of a reference signal together with other uplink transmissions. Instead, specific OFDM symbols are dedicated to DM-RS transmission, and accordingly the uplink reference signal is time-multiplexed with other uplink transmissions from the same UE. Additionally, the very structure of the reference signal ensures low cubit metric on the symbols.

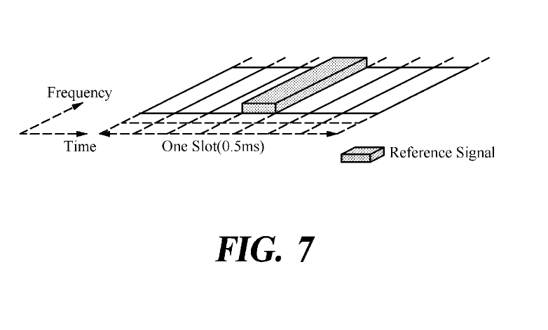

FIG. 7 is a diagram of the structure of an uplink reference signal in a slot in case of PUSCH transmission.

Specifically, in the case of PUSCH transmission, the DM-RS is transmitted on the fourth symbol in each uplink slot. Accordingly, reference signal transmission is performed once per slot and thus twice in each subframe. In case of PUCCH transmission, the number and exact positions of OFDM symbols used for reference signal transmission in slots vary in response to the PUCCH format variation. The same basic structure for reference signal transmission is used for all types of uplink transmission (PUSCH and PUCCH).

The uplink reference signal is defined as a frequency-domain reference signal that is mapped to consecutive inputs (consecutive subcarriers) of an OFDM modulator. Generally, there is no reason to estimate a channel out of a transmission frequency band of PUSCH/PUCCH that is transmitted together with a reference signal. Accordingly, the bandwidth of a reference signal corresponding to the length of a reference signal sequence is supposed to be identical to the transmission bandwidth of PUSCH/PUCCH estimated by the number of subcarriers. This means that in the case of PUSCH transmission, the available PUSCH transmission bandwidth variation supposedly can generate reference signal sequences of correspondingly different lengths. However, the length of a reference signal sequence is always a multiple of 12 because the uplink resource allocation for PUSCH transmission is performed in units of resource blocks having twelve subcarriers.

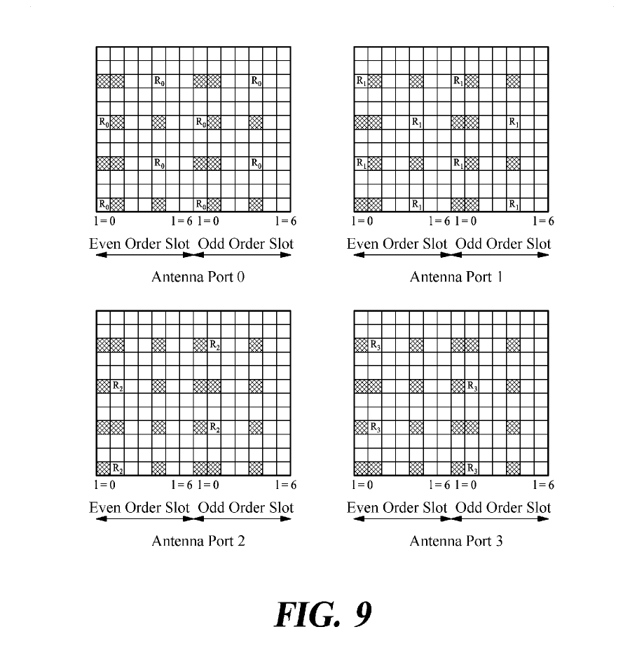

FIG. 9 is a diagram of CRSs or cell-specific reference signals. As shown in FIG. 9, individual CRSs corresponding to four antenna ports are transmitted on all resource blocks in the frequency domain over the whole bandwidth of a downlink cell in every downlink subframe. The CRSs are used to perform channel estimation for coherent demodulation of all downlink physical channels except for PDSCH employing transmission modes 7, 8 and 9 and PMCH. Transmission modes 7, 8 and 9 correspond to non-codebook-based precoding. The CRSs may also be used by a UE to acquire channel-state information (CSI). Estimates of CRSs of the UE are used to determine cell selection and handover.

As such, the overhead ratio of a CRS differs for each of antennas. For example, antenna port 1 or 2 utilizes totally eight subcarriers as the reference signal per 168 subcarriers (per 1 RB) comprised of 12 subcarriers×14 OFDM symbols, and thus average overhead per antenna is about 4.76%. However, antenna port 2 or 3 has the average overhead of 2.38%, that is, the half of the overhead of antenna port 1 or 2. Such differentiation of the reference signal overhead per antenna port is based on the expectation that utilizing three or more antenna ports provides as good MIMO channel environment as to hold the system performance from being degraded even with a low overhead of the channel estimation.

In the various cell topologies such as a femtocell and a picocell with cell coverage whose range is less than 100 m as in the small cell, the radio channel delay characteristics experienced by each cell are different from those of cells with larger coverages, which makes it desirable to design reference signals in consideration of two channel characteristics.

1) Frequency selectivity of the radio channel: On the radio channel defined by delay spread, signals are received through multiple paths with various delay times. Thereby, the radio channel has a delay profile defined by a plurality of delays not by an impulse function. This cannot provide a constant channel gain, but causes a channel to be changed in the frequency domain, which is said to have a frequency selectivity. In the case of small cell, the small coverage and the mostly indoor environment that is different in channel characteristics from a relatively poor environment of mobile communications may reduce the delay spread time to a few nanoseconds. This means an insignificant frequency selectivity to cause a large coherent bandwidth, resulting in similar channel characteristics between neighboring subcarriers. Accordingly, it is now considered to reduce the overhead of the reference signals, that equals in terms of frequency to 6-column frequency interval, as shown in FIG. 9.

2) Time selectivity of the radio channel: In order to reduce the occurrence of frequent handover resulting from the configuration of small cells, small cells are better used by pedestrians or stationary users, and accordingly mobility of the terminal may be restricted to a slow-moving/stationary state. This mitigates the Doppler effect affecting the change of the radio channel to have the time selectivity of the radio channel different from fast-moving objects and then lead to a reduced channel variation between neighboring symbols. This prolongs the coherent time, resulting in a reduced channel variation between temporally neighboring subcarriers. Accordingly, it is better to re-design the reference signals spaced apart by three or four symbols in the time domain as shown in FIG. 9 in order to reduce overhead of the reference signals and use corresponding resources for the data or control channel.

Some embodiments of the present disclosure have the legacy CRS designed with different overheads configured between antennas and with the intervals between reference signals in the time/frequency domain determined taking into account the delay spread and moving speed in a typical mobile communication channel environment. Accordingly, the overhead of reference signals may be reduced within a coverage such as a small cell whose range is less than 100 m and resources may be reallocated to a transmission of data and a control signal. A specific embodiment thereof may be configured as follows.

1) Additional allocation of PDSCH transmission resources through reduction of overhead of the CRS.

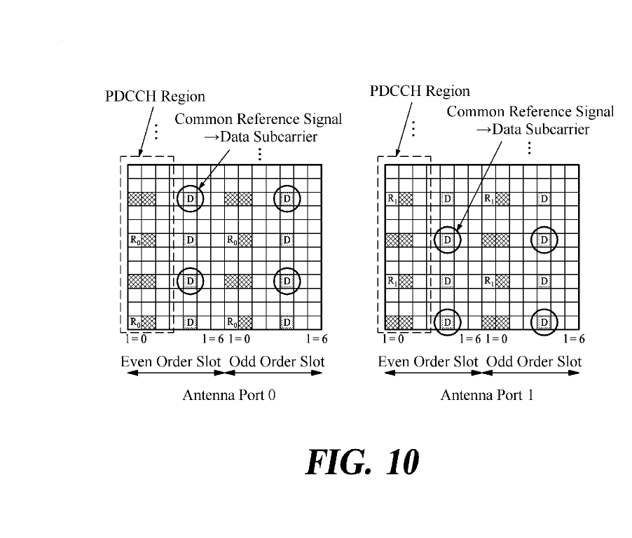

FIG. 10 is an exemplary diagram of reallocating a part of the reference signal to a data region per antenna port 0 or 1 assigned to the CRS. As can be seen from FIG. 10, the channel environment for the small cell has excellent time/frequency selectivity as in the case of antenna port 2 or 3, and thus a part of the reference signal can be reallocated. As illustrated, the initial one to three OFDM symbols forming one subframe serve to transmit a control channel such as the PDCCH, and channel estimation on this channel is very important compared to the data region, and therefore reallocating the reference signal may not be desirable. Accordingly, to maintain the same overhead as at antenna port 2 or 3, two reference signals may be selected from outside the PDCCH region in every slot as shown in FIG. 10 and they may be reallocated to subcarriers for data. In this case, the overhead of the reference signals is reduced from 4.76% to 2.38% per antenna, and thus more than 4.76% of data resources may be added when two or more antennas are used in the small cell.

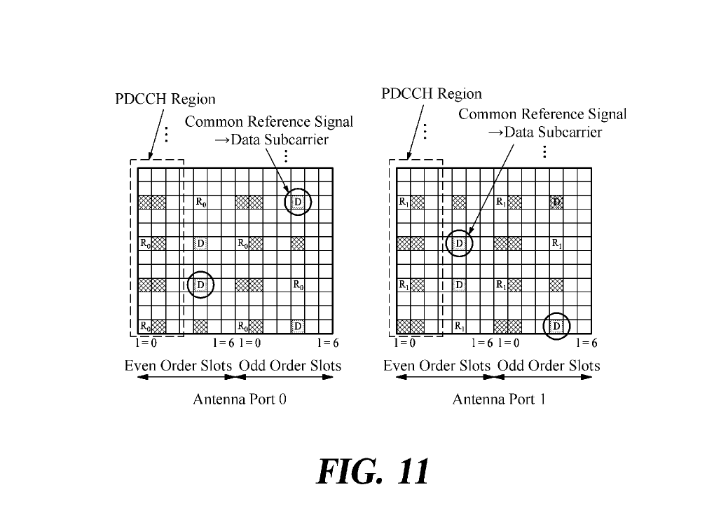

FIG. 11 is an exemplary diagram of reallocating a part of the reference signal outside of a PDCCH region to a data region per antenna port 0 or 1 assigned to the CRS. As can be seen from FIG. 11, the channel environment for the small cell has an excellent time/frequency selectivity as in the case of antenna port 2 or 3, and thus a part of the reference signal can be reallocated. Referring to FIG. 11, the initial one to three OFDM symbols forming one subframe serve to transmit a control channel such as the PDCCH, and channel estimation in this channel is very important compared to the data region, and therefore reallocating the reference signal may not be desirable. Accordingly, having the overhead of the reference signal set to be somewhat higher than the overhead of antenna port 2 or 3 can provide the same expected effect as the currently defined overhead of the reference signal, and further reduce the overhead only in the small cell. In this case, the overhead of the reference signals is reduced from 4.76% to 3.57% per antenna, and thus more than 2.38% of data resources may be added when two or more antennas are used in the small cell.

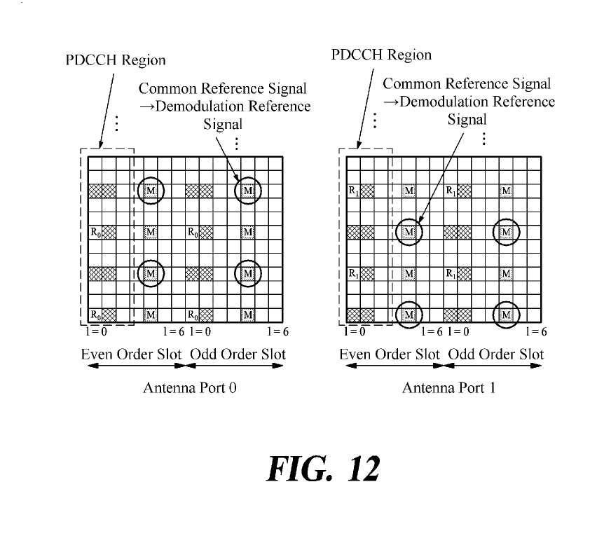

FIG. 12 is an exemplary diagram of reallocating, as a demodulation reference signal, a part of the reference signal per antenna port 0 or 1 assigned to the CRS. As can be seen from FIG. 12, the channel environment for the small cell has an excellent time/frequency selectivity as in the case of antenna port 2 or 3, and thus a part of the reference signal can be reallocated. Referring to FIG. 12, the initial one to three OFDM symbols forming one subframe serve to transmit a control channel such as the PDCCH, and channel estimation in this channel is very important compared to the data region, and therefore reallocating the reference signal may not be desirable. Accordingly, to maintain the same overhead as at antenna port 2 or 3, two reference signals may be selected from outside the PDCCH region in every slot as shown in FIG. 12 and they may be reallocated as demodulation reference signals. In this case, the overhead of the reference signals is reduced from 4.76% to 2.38% per antenna, and thus more than 4.76% of demodulation reference signal resources may be added when two or more antennas are used in the small cell.

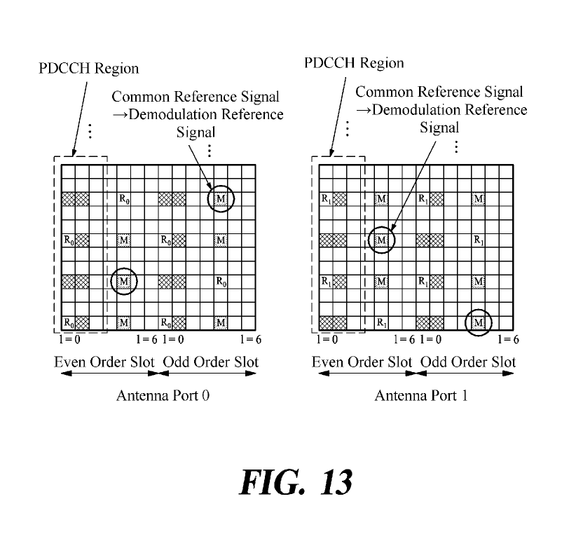

FIG. 13 is an exemplary diagram of reallocating, as a demodulation reference signal, a part of the reference signal outside of a PDCCH region per antenna port 0 or 1 assigned to the CRS. As can be seen from FIG. 13, the channel environment for the small cell has an excellent time/frequency selectivity as in the case of antenna port 2 or 3, and thus a part of the reference signal can be reallocated. Referring to FIG. 13, the initial one to three OFDM symbols forming one subframe serve to transmit a control channel such as the PDCCH, and channel estimation in this channel is very important compared to the data region, and therefore reallocating the reference signal may not be desirable. Accordingly, having the overhead of the reference signal set to be somewhat higher than the overhead of antenna port 2 or 3 can provide the same expected effect as the currently defined overhead of the reference signal, and further reduce the overhead only in the small cell. In this case, the overhead of the reference signals is reduced from 4.76% to 3.57% per antenna, and thus more than 2.38% of demodulation reference signal resources may be added when two or more antennas are used in the small cell.

FIG. 12 or 13 illustrates supporting a plurality of layers in the process of reallocating a part of the CRS as the demodulation reference signal. In FIGS. 12 and 13, each demodulation reference signal may be mapped to each layer and transmitted. Further, some CRSs may be grouped and coded through an orthogonal code to even more distinguish between layers. For example, in the case of FIG. 12, four demodulation reference signals may be grouped to distinguish up to four layers for use through an orthogonal code such as Walsh Code of length 4. Alternatively, four demodulation reference signals may be divided into two groups to support two layers through an orthogonal code of length 2. In further alternative embodiments, in response to eight demodulation reference signals, up to eight layers may be distinguished for transmission through an orthogonal code of length 8, as shown in FIG. 12. In the case of FIG. 13, layers may be distinguished in the same manner by using an orthogonal code such as a length-3 DFT code.

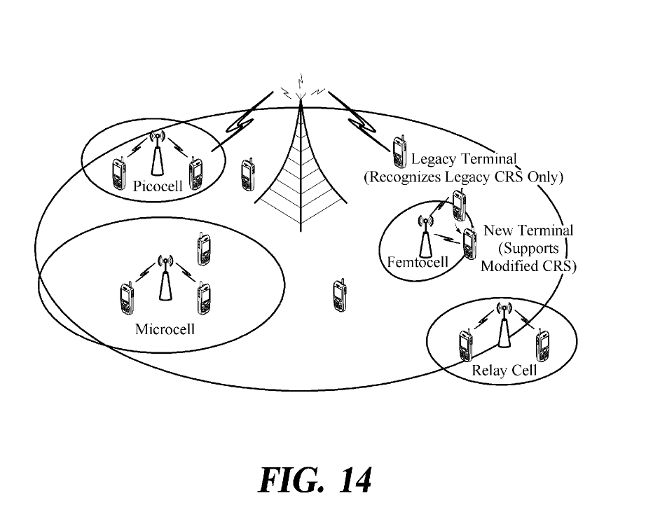

When a part of the CRS is reallocated to data or as a demodulation reference signal, the legacy UE may fail to recognize a modification of the reference signal. This may degrade the performance of the legacy UE that recognizes, as a CRS, the signal reallocated to the data or as a demodulation reference signal. FIG. 14 is a diagram of a small cell network configuration in consideration of the multi-layer cells. Modifications of the CRS in consideration of the channel characteristics of the small cell may fail to allow a consistent mutual recognizability thereof between the legacy UE and an evolved UE, which affects UE performance. As shown in FIG. 14, when a legacy UE receives a modified CRS from a small cell such as a femto cell, the UE may fail to recognize such modification, and may take a signal reallocated to data or as a demodulation reference signal for a CRS to thereby decode, for example, PDCCH, resulting in performance degradation.

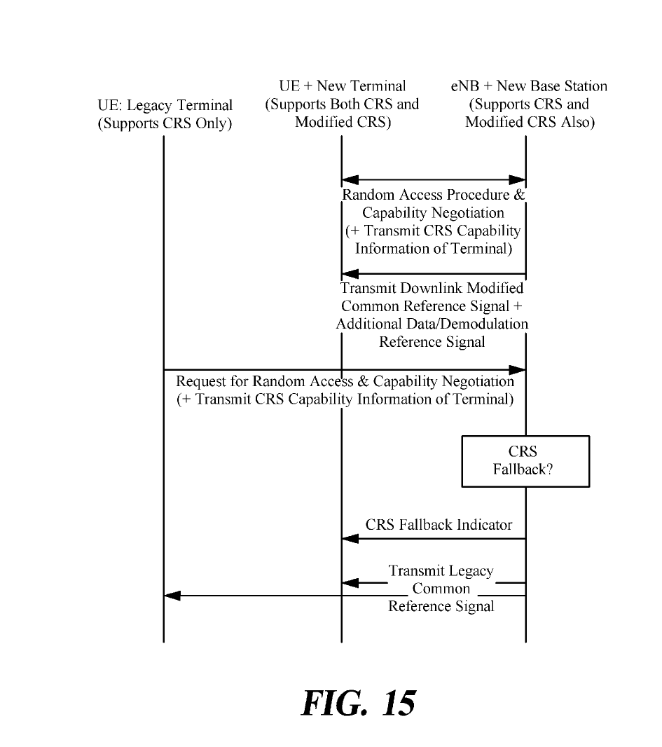

For the sake of repurposing the common demodulation signal, the occasion of the UE accessing the relevant small cell needs to accompany a checking of the information on the CRS transmission mode of the relevant base station along with a negotiation process. FIG. 15 is a diagram of an operational process between new base stations capable of modifying the CRS during a UE accesses a base station. The new base station may take advantage of its own function of modifying the CRS in response to an access from a UE supporting the same function. As shown in FIG. 15, in the process of random access and capability negotiation, the new base station checks the CRS capability of the UE and then activates the function of modifying the CRS for use as additional data or as a demodulation reference signal. Thereafter, the existing legacy UE requests for an access to the relevant base station which then checks the CRS capability to allow or disallow the access from the relevant UE to eventually determine the transmission scheme of the CRS. In FIG. 15, the base station allows the access from the relevant legacy UE, and takes the existing CRS to transmit. In this case, the base station pre-transmits an indicator to inform a new UE of switching to the legacy mode of the CRS.

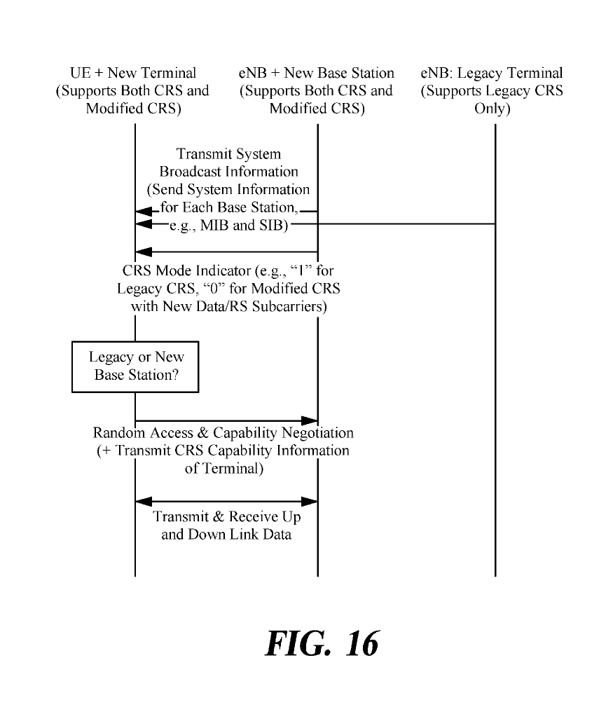

FIG. 16 is a diagram of a base station selection process performed by a UE when a plurality of base stations uses heterogeneous transmission schemes for the CRS. As shown in FIG. 16, a UE supporting a new CRS modification function selects a base station having the new function among a plurality of base stations to be benefited from an improved performance. In this regard, a new UE may receive system information transmitted from respective base stations, and then recognize through the system information whether the relevant base station uses the modified-CRS function, or check CRS for modification of the base stations through a CRS mode indicator which is an additional indicator. Thereby, the UE selects an improved base station, and proceeds to perform a random access to the base station. If the function of the base station is checked through the system information as shown in FIG. 16, decoding of the system information needs to be performed after a synchronization channel is acquired. Thereafter, the same procedure is constantly repeated to retrieve other relevant base stations. Thereby, system efficiency may be lowered, causing an unnecessary consumption of power/time.

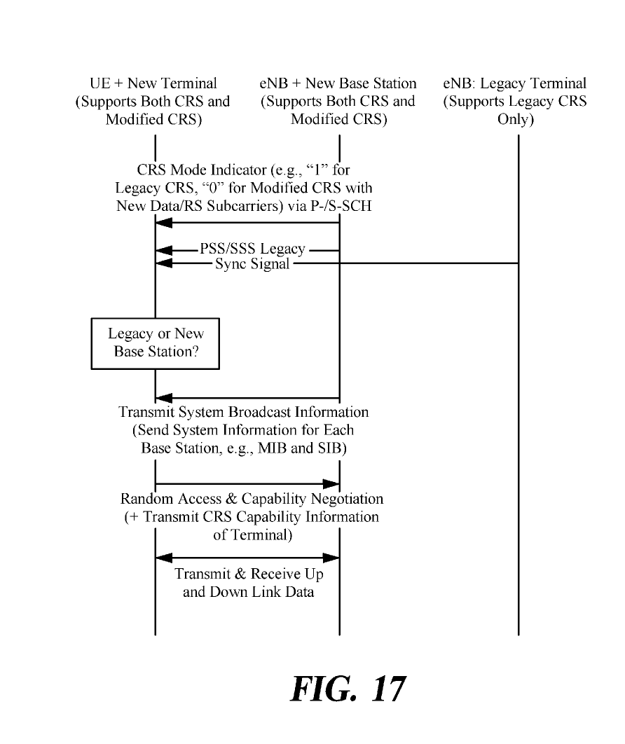

FIG. 17 is a diagram of a process of transmitting an indicator of transmission of a modified CRS over a synchronization channel. In order for a new UE to more quickly retrieve a new base station, a CRS modification indicator is piggybacked on a synchronization channel such as P-/S-SCH. To this end, an information on a phase shift of the synchronization channel may be used, or a specific cell ID may be reserved to serve as an indicator. Alternatively, an additional sequence may be inserted in a synchronization signal through, for example, scrambling so that an indicator may be confirmed by checking whether or not the sequence is detected.

### CROSS-REFERENCE TO RELATED APPLICATION

If applicable, this application claims priority under 35 U.S.C §119(a) of Patent Application No. 10-2013-0048970, Patent Application No. 10-2013-0048972, Patent Application No. 10-2013-0048973, and Patent Application No. 10-2013-0048975, commonly filed on Apr. 30, 2013 in Korea, the entire contents of which are incorporated herein by reference. In addition, this non-provisional application claims priorities in countries, other than the U.S., with the same reason based on the Korean Patent Applications, the entire contents of which are hereby incorporated by reference.

1. A method for operating a base station in a macrocell including multiple base stations coexisting therein, comprising:
selecting one of a plurality of common reference signal generation methods; and
generating a subframe based on a selected common reference signal generation method.

2. The method of claim 1, wherein the plurality of common reference signal generation methods comprises at least two of:
a first common reference signal generation method for using all resources for a common reference signal in the macro cell to transmit the common reference signal;
a second common reference signal generation method for using a part of the resources for the common reference signal in the macro cell to transmit the common reference signal and using the remaining resources to transmit a user data; and
a third common reference signal generation method for using a part of the resources for the common reference signal in the macro cell to transmit the common reference signal and using the remaining resources to transmit a demodulation reference signal.

3. The method of claim 2, wherein the selecting of the common reference signal generation method comprises:
selecting the second method in response to the existence of only user terminals that support the second method.

4. The method of claim 2, wherein the selecting of the common reference signal generation method comprises:
selecting the third method in response to the existence of only user terminals that support the third method.

5. The method of claim 1, wherein the selecting of the common reference signal generation method comprises:
selecting one of the common reference signal generation methods based on a reception capability information of a user terminal that requests an access.

6. The method of claim 1, further comprising:
transmitting an information on the selected common reference signal generation method to a user terminal.

7. The method of claim 1, further comprising:
generating and transmitting the subframe by using the second common reference signal generation method in response to an occurrence of an event to change the common reference signal generation method.

8. The method of claim 7, further comprising:
notifying a user terminal of whether or not the common reference signal generation method is changed.

9. A method for operating a user terminal in a macrocell including multiple base stations coexisting therein, comprising:
requesting an access to the base stations;
receiving, from the base stations, an information about a common reference signal generation method selected from among a plurality of common reference signal generation methods; and
performing a user data reception based on a received information.

10. The method of claim 9, further comprising:
transmitting, to the base stations, an information used to select the common reference signal generation method.

11. The method of claim 10, wherein the information includes a reception capability of the user terminal.

12. The method of claim 9, wherein the receiving of the information comprises:
receiving, respectively from a first base station and a second base station, an information about the common reference signal transmission methods respectively used by the first and second base stations; and
selecting the base station to access based on a received information.

13. The method of claim 12, wherein the first base station operates based on a method for using all resources for a common reference signal in the macro cell to transmit the common reference signal, and
the second base station operates based on a method for using a part of the resources for the common reference signal in the macro cell to transmit the common reference signal and the remaining resources to transmit a user data.

14. The method of claim 12, wherein the first base station operates based on a method for using all resources for a common reference signal in the macro cell to transmit the common reference signal, and
the second base station operates based on a method for using a part of the resources for the common reference signal in the macro cell to transmit the common reference signal and the remaining resources to transmit a demodulation reference signal.

15. The method of claim 12, wherein the receiving of the information comprises:
receiving the information about the common reference signal transmission method over a synchronization channel.
